(19) United States
(12) Patent Application Publication
(10) Pub. No.: US 2005/0276380 A1
(43) Pub. Date: Dec. 15, 2005

(54) Intra oral x-ray imaging

(76) Inventors: Vesa Varjonen, Hyvinkaa (FI); Markku Wederhorn, Nurmijarvi (FI)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/865,675

(22) Filed: Jun. 10, 2004

(51) Int. Cl. H05G 1/64

(52) U.S. Cl. 378/98.9

(57) ABSTRACT

A method for X-ray imaging of mouth with intra oral imaging, method comprising: placing at least one image sensor inside the mouth, radiating from outside of the mouth with X-ray source, receiving X-ray radiation to form at least two sets of image information representing at least two different spectrums of X-ray absorption to achieve a optimal image information for analysis.

The invention relates to intra oral X-ray imaging and image quality and improving resolution thereof.

The intra oral imaging is done by placing a matrix sensor or a film inside mouth and radiating the sensor or film from outside of the mouth with X-ray source. Typically, the X-ray image is used to point out caries or other abnormalities in the teeth. Normally dentist wants to see primary the formation of the bone and teeth. There is not any good solution for examining the soft tissues of the mouth with cost effective way with intra oral X-ray imaging. The typical devices that can differentiate tissues are far too expensive and large for dental use. The structure of bone blurs the small details of the bone, this problem is worse, when there is no focusing possibility like in panoramic dental imaging.

The object of the invention is to improve the quality of the intra oral imaging and improve early detection of alveolitis. A typical quality problem in intra oral imaging is the noise generated by the porous bone material filled with water containing tissue. This bone noise blurs small details and makes difficult to make imaging of soft tissues or small details of bone or teeth. From normal X-ray image, it is also very difficult to make difference between different types of tissue. Another aim of the invention is also to improve existing design with small changes so that updating the image quality is possible without updating the most expensive parts of X-ray device.

The solution for improving the resolution of the intra oral imaging is to use more than one energy level of X-rays for imaging according to the invention described in the independent patent claims. The different X-ray energies may be realized by taking two or more images sequentially and changing the acceleration voltage or by using a filter, which absorbs unwanted part of radiation. The filter may be also between two sensors, so that the first sensor gets full spectrum and later filtered spectrum. The filters may also cover part of pixels in detector matrix to form two or more interleaved images. The sensors may have also different spectral sensitivity in order to get two images with different spectrum of X-ray radiation. These sub images with two of more energy levels of X-ray are used for creating one image with digital image processing.

The high energy spectrum X-radiation is later referred with hard radiation and low energy radiation is referred with soft radiation. The energy values of soft and hard radiation are selected according to the target. The hard and soft radiation have different absorption rate in bone tissue and soft tissue. This is explained later with some numerical examples.

There is no known solution for suppressing the bone noise in reasonably priced and easy-to-use intra oral X-ray device. The methods that use radiation and image sensing outside of the patients head can benefit easier from focusing methods or even computer tomography. The method or means for realizing the invention can be implemented in existing intra oral X-ray device. Advantageously the acceleration voltage is made automatically adjustable by software and/or additionally a filter with actuator mechanism is added to the system. The bone noise can be suppressed by the fact that the soft tissues absorb relatively more low energy X-radiation compared to the absorption ratio of bone. This makes possible to calculate the ratios of tissues for each pixel and thus filter out part of the bone noise. Because a typical electronic intra oral sensor is moderately fast and sensitive, taking the two or more pictures takes so little time, that the sensor is easy to keep stationary during the two or more exposures and the radiation dose of the patient is still reasonably low. The method improves significantly imaging quality of intra oral images, without needing any specific hardware to the intra oral device. The existing intra oral device may need only software update, or a controllable shutter for filter and/or a fast adjustable acceleration voltage supply.

### BRIEF DESCRIPTION OF THE FIGURES

FIG. 1 presents arrangement of intra oral imaging.

FIGS. 2A and 2B present patterned sensors for dual energy imaging.

FIG. 3 presents stacked two layer sensor with different spectral sensitivities.

FIG. 4 presents stacked two layer sensor with filter between sensors to modify spectral sensitivity.

FIGS. 5A and 5B presents dual shot with and without filter between X-ray tube and object with one or two acceleration voltages.

FIGS. 6A and 6B presents dual shot with and without filter between sensor and object, with one or two acceleration voltages.

FIG. 7 presents dual shot with two different sensor and filter between object and sensor, with one or two acceleration voltages.

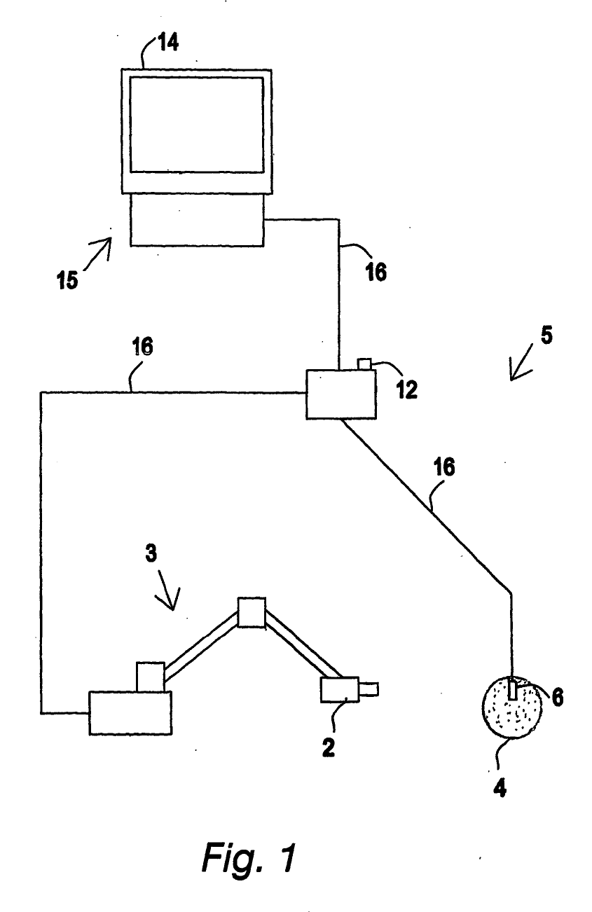

In FIG. 1 is presented an intraoral X-ray device 5 arrangement presenting the arrangement while using the method according to the invention. It is important to notice that this is only an example of the intraoral X-ray device arrangement 5 where the invention is possible to be utilized.

The articulated arm arrangement 3 moves the X-ray source 2 to the right position. The X-radiation begins by pressing the exposure button 12. The X-ray source 2 X-radiates the object 4, which is for example teeth of a patient. The detector 6 detects the X-radiation. The image information which is got by detecting the X-radiation is sent by communication link 16 to the computer 14. The computer comprises the software means 15 to process the image information according to the invention. There can be more than one computer 14 and also the software means 15 can situate in more than one computer 14. For example the first computer 14 is computer which is used in x-ray imaging. The second computer 14 is computer, which is used in processing the image information according to the invention. It is possible to have the second computer 14 far away from the actual medical x-ray device 5. For simplicity in FIG. 7 is shown only one computer 14.

The sensor 6 may comprise many stacked or interleaved sensors or filters to modify the spectrum of the X-ray radiation and the X-ray source may comprise filtering means and preferably the acceleration voltage is adjustable automatically by control means 12, 15.

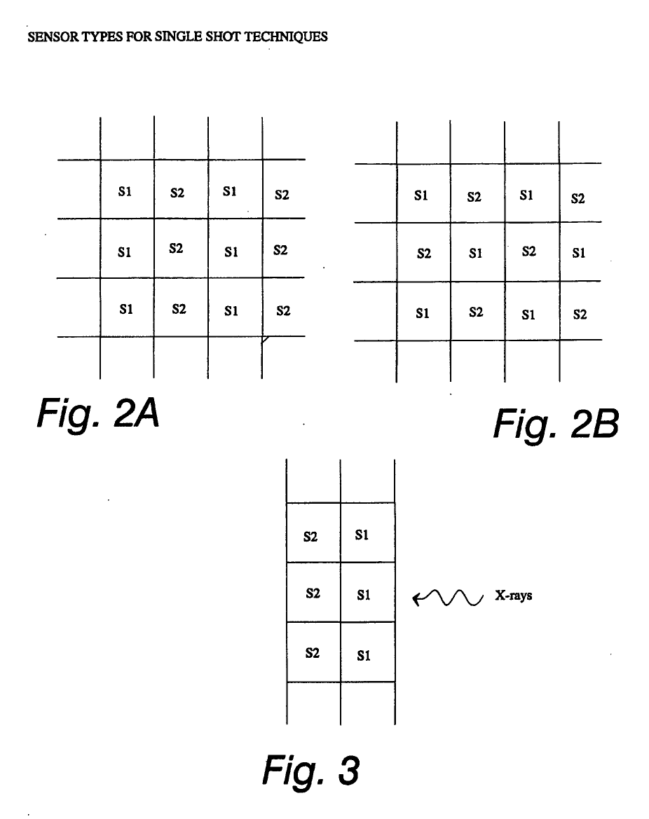

FIGS. 2A and 2B presents sensor means 6 with two (or more) different kind of pixels in one sensor. The X-ray radiation comes from top. The pixel S1 is more sensitive to soft radiation and the pixel S2 is more sensitive to hard radiation. The pixels may be formed from different material and/or filters in front of the pixels may modify the radiation spectrum. IN FIG. 2A the different kind of pixels are arranged in columns and in FIG. 2B the pixels are arranged chessboard like pattern. The two images are taken same time and the images are aligned except the small offset of the neighbouring pixels.

FIG. 3 presents a stacked sensor made of two different sensor material of different sensitivities to hard and soft radiation. The X-rays penetrate through the sensor S1, that in this case is more sensitive to soft radiation and may work as a filter for sensor S2 that is more sensitive to hard radiation. In this way, the two images are exactly aligned.

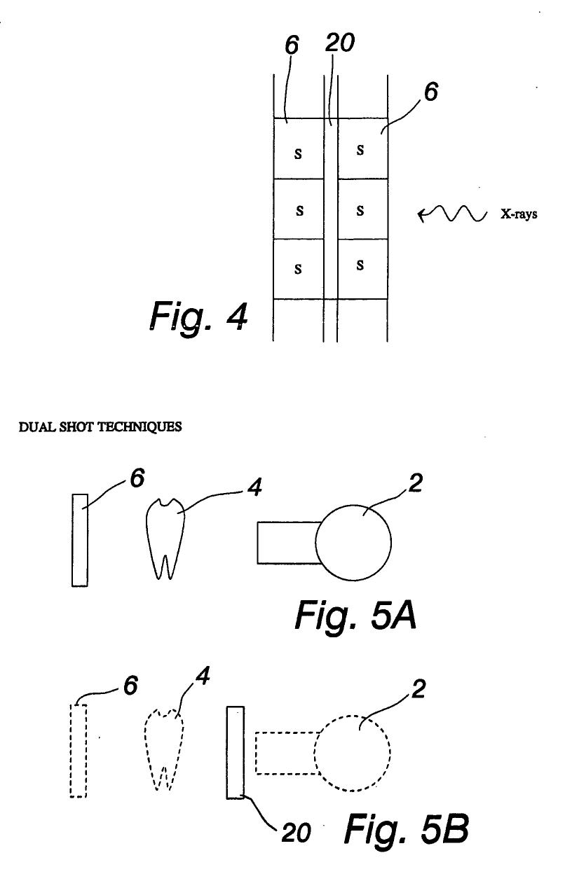

FIG. 4 presents the previous arrangement with additional filter between the two similar sensors S. The filter 20 suppresses the soft radiation of the second filter. This principle can be used advantageously with two different kind of filters.

FIGS. 5A and 5B presents taking two separate shots with the same X-ray source 2. The FIG. 5A presents taking X-ray image with the first lower acceleration voltage V1, and FIG. 5B presents taking second image with second higher voltage V2 to generate harder radiation. The filter 20 suppresses the soft radiation before the target 4 and sensor 6. This arrangement is simple and gives a good selectivity with simple additional hardware.

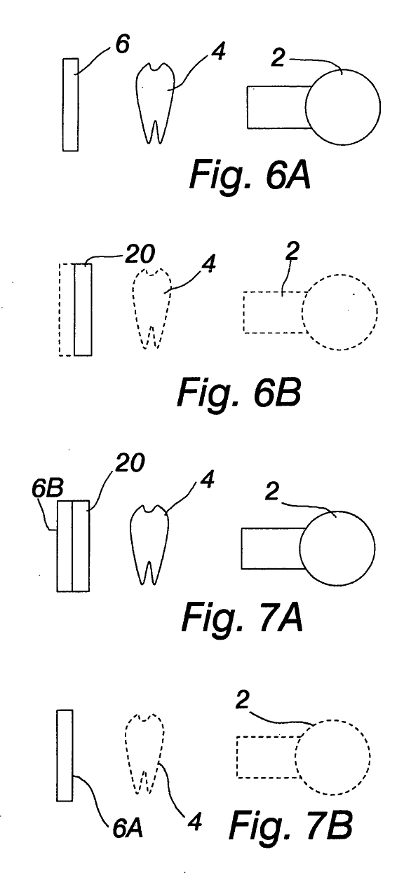

FIG. 6A presents taking two shots and adding a filter between the target 4 and the sensor 6. The X-ray source may change the voltage between the shots. The filter may be added by inserting it from outside of the mouth without taking the sensor away from mouth. This enables to keep the sensor in same position between the shots. An other way is to make an sliding filter arrangement inside the housing of the sensor. The filter may cover only first half of the sensor during first shot and second half in the second shot.

FIGS. 7A and 7B presents taking two images and chancing the sensor means between the images. This may be realised in the sliding arrangement, so that the positions on the sensors are interchanged inside the housing in the mouth in order to make the change of the sensors quickly. The sliding sensors and filters may be used in multiple order inside the housing, for example to take two half images and interchanging the positions of the sensors between the shots. However, it may be advantageous to use also other combinations and take more than two shots. The filter 20 may suppress the soft radiation and the acceleration voltage in FIG. 7B may be lower to make a larger difference between the spectrums of radiations of two shots. The sensors may have different sensitivities. If the sensors are sliding and they cover half of the image area per shot and there is two acceleration voltages in use, the arrangement would need four shots and they will produce 4 different images presenting different spectrums of the absorbed radiation (all combinations of two voltages and two filters resulting four resultant spectrums).

The filtering and processing after taking the images representing different energies of X-ray radiation combines the images as one image. The resulting image may be a coloured or monochromatic presentation. Advantageous known methods for combining the images are at least:
weighted subtraction of intensity data of two sub-images
weighted subtraction of logarithmic intensity data of two sub-images
detailed material modelling using known absorption spectrums and multiple X-ray imaging spectrums.

The different X-ray imaging spectrums can be made by using:
Two or more exposures using multiple acceleration voltages in successive shots.
Two or more exposures using one ore more filter to modify the spectrums to receiving sensor.
Two or more stacked sensors that have different spectral sensitivity.
Two or more stacked sensors having a filter for modifying the spectrum between the sensors.
Sensors with multiple different filters in front of different pixels, the post processing separates the pixels or the reading electronics is arranged so that the different images can be read separately.
Any combination of previous.

The methods can be combined in any way, so that with stacked sensors can be used also two shots with two different X-ray radiation spectrums generated changing the acceleration voltage and/or using filter between the radiation source and receiving sensor.

Following attenuation factors are measured for different average energy spectrums of X-ray radiation:

| Average energy | Soft tissue | Bone tissue | Ratio Soft/Bone tissue |
|---|---|---|---|
| 33.9 kV | 0.3185 | 0.9669 | 0.33 |
| 42.8 kV | 0.2534 | 0.5701 | 0.44 |
| 50.7 kV | 0.2238 | 0.4098 | 0.55 |

The differences in the ratios of the absorption rates means, that the ratios of soft tissue and bone tissue in each pixel can be calculated or approximated mathematically from two or more images representing attenuation of different spectrums of radiation. With software, for example linear processing method the two or mere images can be combined into soft tissue or bone image. From soft tissue image the bone structural information is removed. Respectively from the bone image all the soft tissue information is removed. When the structural noise is removed, it will make easier to detect faint contrast changes in either soft or bone image, whatever is interesting. The simplest method tested was weighted linear subtraction of logarithmic intensity data. The simple embodiment of the method is slider window display, where the user may select interactively the mixture of two component images. This way the user can fine-tune the subtraction parameters to suppress the interfering part of the combined image. The tests results were showing a remarkable suppression of the bone noise and cancellation of either soft or bone materials with different slider positions.

The invention is not limited to the form of claims.

1. A method for X-ray imaging of mouth with intra oral imaging, method comprising:
placing at least one image sensor inside the mouth,
radiating from outside of the mouth with X-ray source,
receiving X-ray radiation to form at least two sets of image information representing at least two different spectrums of X-ray absorption to achieve a optimal image information for analysis.

2. A method for X-ray imaging of mouth with intra oral imaging, method comprising:
placing at least one image sensor inside the mouth,
radiating from outside of the mouth with X-ray source at least two times with different received spectrum in the receiving sensor,
receiving X-ray radiation to form at least two sets of image information representing at least two different spectrums of X-ray absorption.

3. A method according to the claim 2, characterized in that the different spectrums are generated using different acceleration voltage levels in the X-ray source outside of the mouth.

4. A method according to the claim 2, characterized in that the different spectrums are generated using filtering of the X-radiation between the X-ray source and at least one the image sensor.

5. A method for X-ray imaging of mouth with intra oral imaging, method comprising:
placing at least one image sensor inside the mouth,
radiating from outside of the mouth with X-ray source radiating with multiple energy levels in the same time
receiving X-ray radiation to form at least two sets of image information representing at least two different spectrums of X-ray absorption by using spectrum selective method in receiving to achieve an optimal image information for analysis.

6. A method according to the claim 5, characterized in that the different spectrums are generated to for two image sensors by placing a filter between two stacked sensors inside the mouth.

7. A method according to claim 5, characterized in that the received spectrums are separated by using at least two imaging sensors that have different spectral sensitivity.

8. A method according to claim 5, characterized in that the received spectrums are separated by using filters in front of separate pixels, rows or lines of pixels in order to form two interleaved sets of image information with one sensor and one exposure.

9. A method according to the claim 1, characterized in that the images generated from different spectrums of X-radiation are combined using digital image processing to improve the image quality and detail resolution.

10. A device for X-ray imaging of mouth with intra oral imaging, having means for radiating outside of the mouth and at least one image sensor to be placed inside the mouth, characterized in that the device comprises means to automatically form at least two sets of image information using at least two different spectrums for absorbed radiation and means to enable post processing of said sets of image information either in the same device or in another device.

11. A device according to the claim 10, characterized in that the device comprises means for automatic and fast adjusting the acceleration voltage of the X-ray source to change the spectrum between two or more exposures.

12. A device according to the claim 11, characterized in that the device comprises filtering means of the X-radiation between the X-ray source and at least one image sensor for modifying the spectrum of the X-ray radiation spectrum to form at least two successive sets of image information representing different spectrums of absorbed radiation.

13. A device according to the claim 10, characterized in that the device comprises filtering means between at least two stacked sensors for modifying the spectrum of the X-ray radiation so that sensors have different received spectrums.

14. A device according to the claim 7, characterized in that the device comprises at least two stacked sensors having different spectral sensitivity.

15. A device according to the claim 7, characterized in that the device comprises a sensor covered partly with different kind of filtering means to form two interleaved sets of image information with one sensor and one exposure.

16. A device according to the claim 7 characterized in that the device comprises means to combine at least two images representing the different spectrums of X-ray absorption into one image automatically.

17. A device according to the claim 7 characterized in that the device comprises means to send said two set of image information for post processing outside of the device.
